(19) United States
(12) Patent Application Publication
(10) Pub. No.: US 2005/0092951 A1
(43) Pub. Date: May 5, 2005

(54) Magnetic valve

(76) Inventor: Thomas Groetzinger, Gehrden (DE)

Correspondence Address: MURAMATSU & ASSOCIATES;Suite 225, 7700 Irvine Center Drive, Irvine, CA, 92618, US

(21) Appl. No.: 10/973,142

(22) Filed: Oct. 26, 2004

(30) Foreign Application Priority Data
Nov. 3, 2003 (DE) 103 51 106.7
May 24, 2004 (DE) 04 012 255.8

(51) Int. Cl. F16K 31/02

(52) U.S. Cl. 251/129.15

(57) ABSTRACT

A solenoid valve has a valve housing with valve seat and a valve member, the valve member co-operating between an open and a closed position with the valve seat, as well as an electromagnet having an armature that, together with at least one spring, acts on the valve member so that in the energized state of the electromagnet, the valve member is brought into the one position, and in the un-energized state is brought into the other position. The valve housing has two opposite connection sides, by means of which the valve housing can be coupled selectively to the electromagnet in order to create either a valve that is open in the un-energized state or a valve that is closed in the un-energized state. Alternatively, the valve housing is constructed so that the valve seat and the valve member can be arranged selectively in a first or a second position in the valve housing.

### FIELD OF THE INVENTION

The invention relates to a solenoid valve having a valve housing with a valve seat and a valve member, the valve member co-operating between an open and a closed position with the valve seat, and having an electromagnet with an armature that together with at least one spring acts on the valve member so that in the energized state of the electromagnet the valve member is brought into the one position and in the un-energized state is brought into the other position. The invention relates furthermore to a kit for a solenoid valve that is open in the un-energized state or closed in the un-energized state.

According to the installation circumstances, a normally closed (closed when un-energized) valve or a normally open (open when un-energized) valve is preferred. Different components and modules are needed to produce such NC and NO valves.

### SUMMARY OF THE INVENTION

It is therefore an object of the invention to simplify manufacture of such valves and to reduce the costs.

That object is achieved in accordance with the invention by the features defined in the appended claims.

A first version of the solenoid valve according to the invention substantially comprises a valve housing with valve seat and a valve member, the valve member co-operating between an open and a closed position with the valve seat, and an electromagnet with an armature that, together with at least one spring, acts on the valve member so that in the energized state of the electromagnet the valve member is brought into the one position and in the un-energized state is brought into the other position. The valve housing comprises two opposite connection sides, by means of which the housing can be selectively coupled to the electromagnet to create either a valve that is open in the un-energized state or a valve that is closed in the un-energized state.

According to a second version, the solenoid valve substantially comprises a valve housing with valve seat and a valve member, the valve member co-operating between an open and a closed position with the valve seat, and an electromagnet with an armature that, together with at least one spring, acts on the valve member so that in the energized state of the electromagnet the valve member is brought into the one position and in the un-energized state is brought into the other position. The valve housing is here constructed so that the valve seat and the valve member can be arranged either in a first or in a second position in the valve housing, in order to create either an opening valve that is open in the un-energized state or an opening valve that is closed in the un-energized state.

According to a third version, a kit for a solenoid valve that is open in the un-energized state or closed in the un-energized state and has at least one valve housing, a valve seat, a valve member and an electromagnet with an armature is provided, the valve member co-operating between an open position and a closed position with the valve seat, and the armature, together with at least one spring, acting on the valve member so that in the energized state of the electromagnet the valve member is brought into the one position and in the un-energized state is brought into the other position. The valve seat and the valve member can be arranged in the valve housing/valve housings both to create a valve that is open in the un-energized state and to create a valve that is closed in the un-energized state.

The different versions enable identical components to some extent to be used for both types of valve. This brings considerable advantages in tool manufacture, stock-keeping and parts costs.

Further constructions of the invention form the subject matter of the subsidiary claims.

According to a preferred exemplary embodiment, an annular seal is provided between the valve housing and the valve member, the travel of the valve member from one into the other position being measured so that the annular seal merely flexes. In the case of known constructions involving a pressure equalisation, a translatory movement between the valve member and the annular seal is necessary, which causes considerable sliding friction.

In addition, a further spring can be provided, the two springs coming into contact with the valve member at opposite sides thereof. If the two springs moreover have the same spring power, identical spring forces act on the valve member in both installation situations of the valve housing.

According to a special construction, the solenoid valve is in the form of a pressure-compensated valve, and the valve has at least two openings respectively as inlet and outlet, which openings can be interchanged since the valve operates in both directions.

### BRIED DESCRIPTION OF THE DRAWINGS

FIG. 1 is a cross-sectional view of a first version of a solenoid valve that is open in the un-energized state.

FIG. 2 is a cross-sectional view of the first version of a solenoid valve that is closed in the un-energized state.

FIG. 3 is a cross-sectional view of a second version of a solenoid valve that is open in the un-energized state.

FIG. 4 is a cross-sectional view of the second version of a solenoid valve that is closed in the un-energized state.

### DETAILED DESCRIPTION OF THE INVENTION

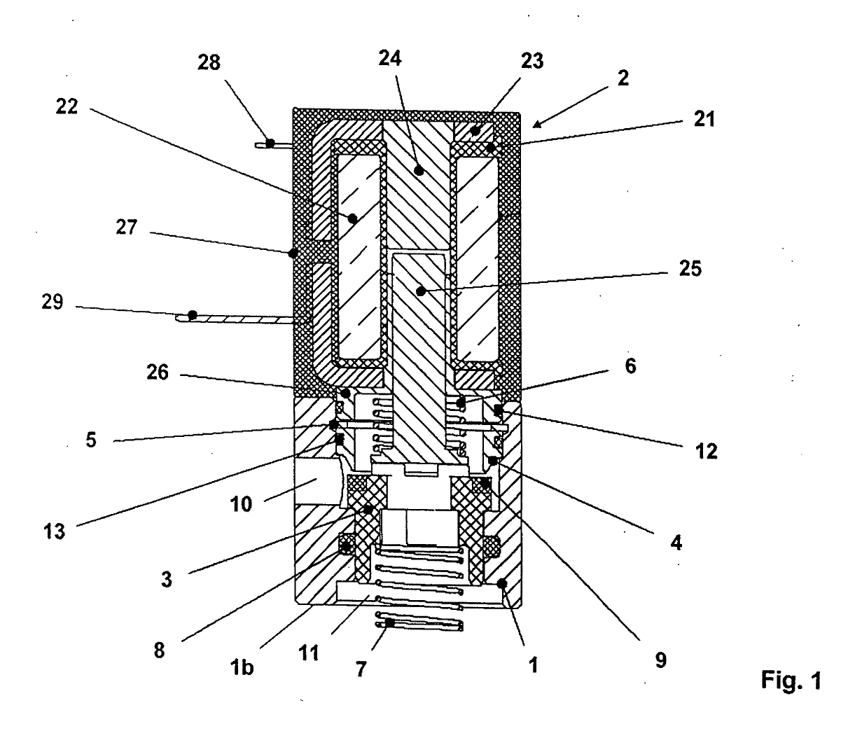

The solenoid valve according to FIG. 1 essentially comprises valve housing 1 and an electromagnet 2.

The electromagnet 2 is constructed in a manner known per se. Thus, a coil former 21 having a winding 22 is provided, and also a yoke 23. In the coil former 21 there is furthermore a magnet core 24 as well as an armature 25 guided by way of a pole tube 26.

The entire electromagnet is surrounded by a casing 27, with contact pins 28 and an earth lug 29 being led out of the casing.

In the valve housing there is arranged a valve member 3, which co-operates between an open and a closed position with a valve seat 4. The valve seat 4 is fixed to the valve housing 1, for example, by a securing ring 5.

The armature 25 furthermore co-operates with a spring 6, such that in the un-energized state the valve member is brought into its open position shown in FIG. 1. In the energized state of the electromagnet, the armature 25 is attracted by the magnet core 24 so that the valve member, assisted by a spring 7 acting at the other end of the valve member, assumes its closed position.

The valve member 3 is thus slidably arranged in the valve housing 1, an annular seal 8 that effects a seal either towards the outside or towards the inside being provided between the valve housing and the valve member. The travel of the valve member from the one into the other position is preferably determined so that the annular seal merely flexes. In this way, otherwise considerable sliding friction can be avoided.

In its region coming into contact with the valve seat, the valve member 3 is moreover provided with a valve rubber 9. The solenoid valve illustrated has two openings 10 and 11, serving either as inlet or as outlet. Furthermore, a seal 12 is provided between pole tube 26 and valve housing 1 and a seal 13 is provided between valve seat 4 and valve housing.

The spring 6 is supported at one end on the pole tube 26 of the electromagnet and at its other end on a flange-like extension of the armature 25. The further spring 7 engages at one end on an inner shoulder of the valve member 3 and at its other end, for example, on a flange, not illustrated, to which the solenoid valve is fastened. To create a pressure-equalised valve, the seal-effecting diameter of the annular seal 8 between valve housing 1 and valve member 3 is dimensioned so that it corresponds to the seal-forming diameter of the valve seat 4.

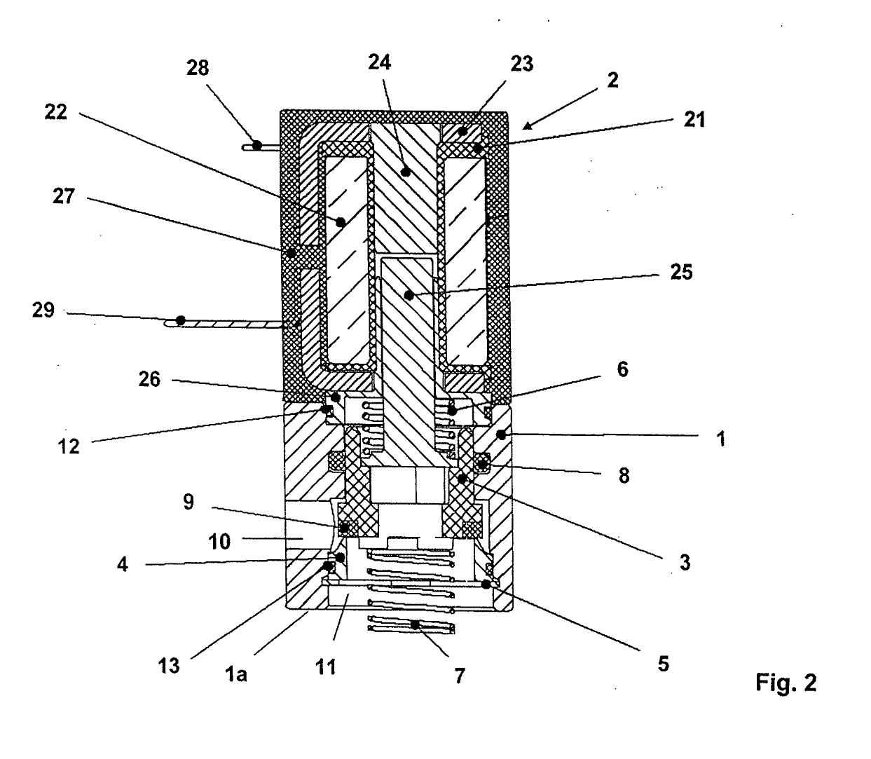

The special feature of the solenoid valve illustrated is explained in detail hereinafter with further reference to FIG. 2. Since both solenoid valves have the same components, the same reference numerals were used.

The special feature comprises the fact that the valve housing 1 has two opposite connection sides 1a and 1b, by means of which the valve housing can be selectively coupled to the electromagnet to produce a valve that is either open in the un-energized state or closed in the un-energized state. In FIG. 1, the valve housing 1 is coupled with its connection side 1a to the electromagnet and forms a valve that is open in the un-energized state. In FIG. 2, the valve housing has been rotated through 180°, that is, is coupled to the valve housing with its connection side 1b and forms a valve that is closed in the un-energized state.

In the case of the solenoid valve shown in FIG. 2, in the un-energized state of the electromagnet the valve member 3 is pressed by way of the armature 25 and the spring 6 towards the valve seat 4, so that the passage between the two openings 10 and 11 is closed. In the energized state, the armature 25 is attracted by the magnet core 24 against the force of the spring 6, so that the valve member 3 is lifted away from the valve seat 4 by the force of the further spring 7 and the connection between the two openings 10 and 11 is unblocked.

The two types of valve shown in FIGS. 1 and 2 can thus be created using identical components and modules. This brings considerable advantages in tool manufacture, stock-keeping and parts costs.

If the solenoid valve is designed as a pressure-compensated valve, the openings 10 and 11 can additionally be interchanged respectively as inlet and outlet. So that in the assembled state of the solenoid valve one is able to recognize from the outside whether the solenoid valve is open in the un-energized state or closed in the un-energized state, it would be possible to arrange the lateral opening 10 so that it is not central between the two connection sides 1a and 1b (see FIGS. 1 and 2). In this way the two solenoid valves differ externally and their function can be ascertained.

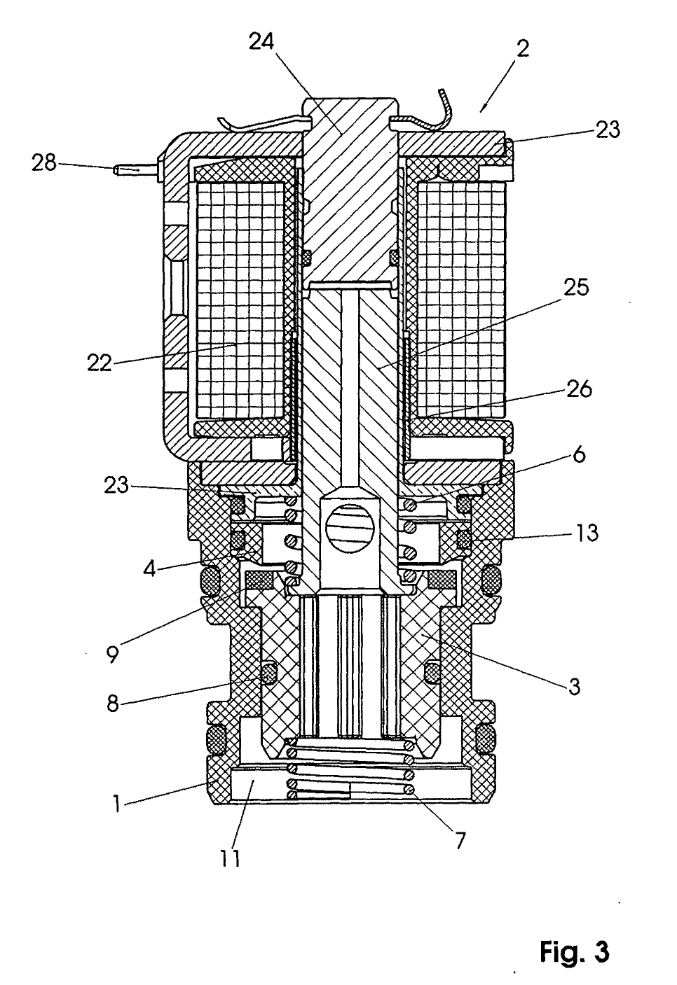

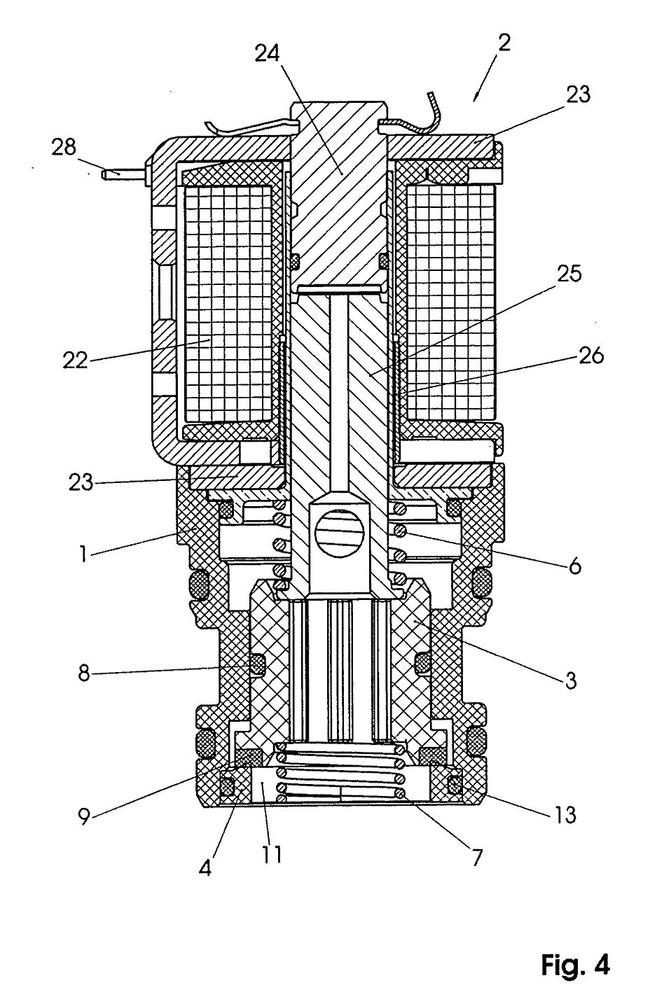

A second version of a solenoid valve is illustrated in FIGS. 3 and 4. For ease of understanding the same reference numerals have been used for identical components.

The difference from the exemplary embodiment illustrated in FIGS. 1 and 2 is that the valve housing here does not have two opposite connection sides; on the contrary, the valve housing is constructed so that the valve seat and the valve member can be arranged either in a first or in a second position in the valve housing, in order to produce either a valve that is open in the un-energized state or a valve that is closed in the un-energized state.

The valve housing 1 is coupled to the electromagnet 2 in the region of the yoke 23 and the pole tube 26. Here too, a valve member 3 that co-operates between an open and a closed position with a valve seat 4 is arranged in the valve housing. The valve seat 4 is fixed to the valve housing 1, for example, by means of a securing ring, by ultrasound welding, adhesion or frictional contact.

The armature 25 co-operates with a spring 6 so that in the un-energized state the valve member 3 is brought into its open position, shown in FIG. 3. In the energized state of the electromagnet, the armature 25 is attracted by the magnet core 24, so that the valve member, assisted by the spring 7 acting on the lower end of the valve member, assumes its closed position. The travel of the valve member 3 from the one into the other position is again determined so that an annular seal 8 merely flexes. In respect of all the remaining components, the solenoid valve corresponds to the first exemplary embodiment described above.

In the case of the solenoid valve according to FIG. 4, the valve member 3 and the valve seat 4 have been inserted on the other side of the valve housing, that is, within the opening 11. With this arrangement, in the un-energized state of the electromagnet the valve seat 3 is pressed by way of the armature 25 and the spring 6 against the valve seat 4, so that the opening 11 is closed. In the energized state, the armature 25 is attracted, against the force of the spring 6, by the magnet core 24, so that the valve member 3 is lifted from the valve seat 4 by the force of the further spring 7 and the opening 11 is unblocked again.

Whereas in the case of the first exemplary embodiment according to FIGS. 1 and 2 the entire valve housing with integrated valve member and valve seat is rotated, in the case of the exemplary embodiment shown in FIGS. 3 and 4 the housing is coupled with the same connection side to the electromagnet and the valve member and the valve seat are merely inserted into the valve housing from the other side.

The two exemplary embodiments can therefore use the same components to produce a valve that is open in the un-energized state or a valve that is closed in the un-energized state.

In accordance with a third embodiment, which corresponds essentially to the exemplary embodiments shown in FIGS. 3 and 4, a respective separate valve housing is provided for the valve that is open in the un-energized state and for the valve that is closed in the un-energized state; nevertheless, the same valve members and valve seats can be used. With this version, there are admittedly two different valve housings, but at least the same valve members and valve seats can be used for both valves.

In the case of a kit comprising essentially at least one valve housing 1, a valve seat 4, a valve member 3 and an electromagnet 7, a solenoid valve that is open in the un-energized state or closed in the un-energized state can be formed in accordance with one of the three above-described versions.

1. A solenoid valve having a valve housing (1) with valve seat (4) and a valve member (3), the valve member co-operating between an open and a closed position with the valve seat, as well as an electromagnet (2) having an armature (25) that, together with at least one spring (6), acts on the valve member (3) so that in the energized state of the electromagnet the valve member is brought into the one position and in the un-energized state is brought into the other position,
characterised in that the valve housing (1) has two opposite connection sides (1a, 1b), by means of which the valve housing can be coupled selectively to the electromagnet (2) in order to create either a valve that is open in the un-energized state or a valve that is closed in the un-energized state.

2. A solenoid valve having a valve housing (1) with valve seat (4) and a valve member (3), the valve member co-operating between an open and a closed position with the valve seat, as well as an electromagnet (2) having an armature (25) that, together with at least one spring (6), acts on the valve member (3) so that in the energized state of the electromagnet the valve member is brought into the one position and in the un-energized state is brought into the other position,
characterised in that the valve housing (1) is constructed so that the valve seat and valve member can be arranged either in a first or a second position in the valve housing in order to create either a valve that is open in the un-energized state or a valve that is closed in the un-energized state.

3. A solenoid valve according to claim 1, characterised in that an annular seal (8) is provided between the valve housing (1) and the valve member (3), the travel of the valve member from the one into the other position being determined so that the annular seal merely flexes.

4. A solenoid valve according to claim 1, characterised in that the valve has at least two openings (10, 11), which serve as respectively inlet and outlet, one of the two openings being provided in the connection side (1a; 1b) opposite the electromagnet (2).

5. A solenoid valve according to claim 1, characterised in that the valve has at least two openings (10, 11), one of the two openings being provided in the connection side (1a; 1b) opposite the electromagnet and the other opening being arranged transversely thereto in a lateral wall of the valve.

6. A solenoid valve according to claim 1, characterised in that a further spring (7) is provided, the two springs (6, 7) coming into contact with the valve member (3) at opposite sides thereof.

7. A solenoid valve according to claim 1, characterised in that the solenoid valve is in the form of a pressure-compensated valve, and in that the valve has at least two openings (10, 11) as respectively inlet and outlet, which can be interchanged.

8. A solenoid valve according to claim 1, characterised in that the solenoid valve is in the form of a pressure-compensated valve.

9. A solenoid valve according to claim 1, characterised in that an annular seal (8) is provided between valve housing (1) and valve member (3), the seal-forming diameter of the annular seal (8) corresponding to the seal-forming diameter of the valve seat (4).

10. A kit for a solenoid valve that is open in the un-energized state or closed in the un-energized state, comprising:
at least one valve housing (1),
a valve seat (4),
a valve member (3), the valve member co-operating between an open and a closed position with the valve seat,
as well as an electromagnet (2) having an armature (25) that, together with at least one spring (6), acts on the valve member (3) so that in the energized state of the electromagnet the valve member is brought into the one position and in the un-energized state is brought into the other position,
characterised in that the valve seat and the valve member can be arranged in the valve housing/valve housings both to form both a valve that is open in the un-energized state and to form a valve that is closed in the un-energized state.
